(19) United States
(12) Patent Application Publication
(10) Pub. No.: US 2026/0334368 A1
(43) Pub. Date: Oct. 29, 2026

(54) A WINDROW FORMING DEVICE

(71) Applicant: PLOEGER OXBO HOLDING B.V., Roosendaal (NL)

(72) Inventors: Hendrik Willem BREURE, Roosendaal (NL); Marinus Adriaan GROOTJANS, Roosendaal (NL)

(21) Appl. No.: 19/111,643

(22) PCT Filed: Sep. 5, 2023
(86) PCT No.: PCT/NL2023/050456

§ 371 Date: Mar. 13, 2025

(30) Foreign Application Priority Data
Sep. 16, 2022 (NL) 2033062

(51) Int. Cl. A01D 89/00

(52) U.S. Cl. CPC A01D 89/002; A01D 89/004

(57) ABSTRACT

A windrow forming device is movable over ground in a direction of travel. The device is provided with a pick-up mechanism for picking up a product from the ground. The pick-up mechanism includes a pick-up rotor with a rotation axis, at least one transport mechanism, for example a conveyor belt, arranged to convey the picked-up material in at least one transport direction extending sidewards with respect to the direction of travel, and to deposit the material on the ground for forming a windrow, and at least one ground following member.

### CROSS-REFERENCE TO RELATED APPLICATION

The present application is a National Stage Application of PCT International Application No. PCT/NL2023/050456 filed on Sep. 5, 2023, which claims priority to Patent Application 2033062, filed with The Netherlands Patent Office on Sep. 16, 2022, the disclosure of which is incorporated herein by reference in its entirety.

### FIELD OF THE INVENTION

The invention relates to a windrow forming device which is movable over ground in a direction of travel, wherein the device is provided with a pick-up mechanism for picking up a product from the ground wherein the pick-up mechanism comprises a pick-up rotor with a rotation axis, at least one transport mechanism, for example a conveyor belt, arranged to convey the picked up material in at least one transport direction extending sidewards with respect to the direction of travel, and to deposit said material on the ground for forming a windrow, and at least one ground following member.

The invention also relates to a self-propelled agricultural machine, for example a self-propelled merger, or a pulled agricultural machine comprising at least one windrow forming device as specified in this disclosure.

### SUMMARY OF THE INVENTION

WO2022045883 discloses a windrow forming device and a self-propelled agricultural machine, in particular a merger, or a pulled agricultural machine comprising at least one windrow forming device. Although the known windrow forming device gives excellent results for forming windrows on the land at relatively high speeds of travel, one object of the present invention is further improvement of the windrow forming device, in particular an improved pick-up of product from the ground.

The windrow forming device is movable over ground in a direction of travel. The device is provided with:
a first and a second pick-up mechanism for picking up a product from the ground, each pick-up mechanism comprises a pick-up rotor with a rotation axis;
at least one transport mechanism, for example a conveyor belt, arranged to convey the picked up material in at least one transport direction extending sidewards with respect to the direction of travel, and to deposit said material on the ground for forming a windrow;
at least one ground following member, wherein by means of the ground following member the first pick-up mechanism is pivotably mounted about a pivot axis to the second pick-up mechanism such that each pick-up mechanism is configured to assume a first orientation in which the rotation axis of the pick-up mechanism extends parallel to the transport direction and at least a second orientation in which the rotation axis of the pick-up mechanism extends non-parallel to the transport direction.

The windrow forming device is provided with at least two pick-up mechanisms, instead of one as disclosed in WO2022045883. The windrow forming device of this disclosure provides a relatively large working unit width of the device and improves pick-up of product from the ground by means of the two pick-up mechanisms, because by means of the ground following member the first pick-up mechanism is pivotably mounted about a pivot axis to the second pick-up mechanism such that each pick-up mechanism is configured to assume a first orientation in which the rotation axis of the pick-up mechanism extends parallel to the transport direction, for example horizontally, and at least a second orientation in which the rotation axis of the pick-up mechanism extends non-parallel to the transport direction, for example non-horizontal.

The working unit width of the device extends in a direction substantially traverse to the direction of travel. It is possible by means of the two pick-up mechanisms to provide a device with a larger working width than the working width of the single pick-up mechanism as disclosed in WO2022045883 without the risk of decreased pick-up of product. Improved ground following capability of the pick-up mechanisms will increase pick-up of product and pick-up quality. In other words, the first and second pick-up mechanisms are able to pivot with respect to each other about a pivot axis which results in improved ground following capability of the pick-up mechanisms, in particular for uneven grounds. In addition, the device of this disclosure decreases the risk or decreases the impact that components, for example tines, of the pick-up mechanism contact obstacles and/or the ground which may cause damage to the pick-up mechanism. In addition, pick-up of product from the ground is improved and/or the pick-up of soil, in particular on an uneven ground, can be reduced.

As a result of the ground following member of the device, a relatively simple, mechanically strong and reliable device can be provided from a constructional point of view and/or with a long lifespan. The pick-up mechanisms may be pivotably mounted to other components of the device, such as a rigid frame, which may further improves the aforementioned constructional beneficial properties. The term rigid in this disclosure means that the respective component should be considered to be stationary with respect to other components of the device, even when the complete windrow device, including for example the rigid frame, can be moved by (or in) an agricultural machine. The term pivotably in this disclosure means that the respective component should be considered to be moveable or rotatable with respect to other components of the device.

Each pick-up mechanism of the windrow forming device comprises a pick-up rotor with a rotation axis, wherein if the pick-up mechanisms are in a working position and moved in the direction of travel over an uneven ground the rotation axes of the pick-up rotors of the pick-up mechanisms will be misaligned and the rotation axes will be aligned on an even ground, i.e. on a flat ground without obstacles the rotation axes of the pick-up rotors of the pick-up mechanisms are aligned along a straight line, for example on a flat horizontal ground a horizontal line. The rotation axes of the pick-up rotors of the pick-up mechanisms extend in a sidewards direction to the direction of travel in use, in particular substantially traverse to the direction of travel.

In one aspect, the device is further provided with a rigid frame, for example a frame of the at least one transport mechanism, wherein the first and the second pick-up mechanism are adapted to move or pivot with respect to the rigid frame. None of the pick-up mechanisms of the windrow forming device is connected in a non-pivotable manner to the rigid frame which includes the frame of the conveyor belt, such that each pick-up mechanism of the windrow forming device of this disclosure can move or rotate with respect to the rigid frame.

In one further aspect, the device is provided with at least three ground following members, wherein the ground following member is a central ground following member located between two outer ground following members.

The claims are incorporated in this description by reference.

It is also an object to provide an improved agricultural machine. This object is achieved with the agricultural machine as claimed. The agricultural machine may be a self-propelled agricultural machine or a pulled agricultural machine, wherein the agricultural machine comprises at least one windrow forming device of this disclosure, preferably at least two of these windrow forming devices. In the agricultural machine, the at least one windrow forming device may be moveable from a transport position to a working position, and vice versa, wherein in the working position a maximum width of the machine seen in a direction traverse to the direction of travel is larger by means of the at least one device than in the transport position, preferably at least 1,5 times larger.

Finally, the invention also relates to the use of an agricultural machine or the windrow forming device of this disclosure.

The above-described aspects will be explained below by means of exemplary embodiments in combination with the figures. However, the invention is not limited to the exemplary embodiments described below. Rather, a number of variants and modifications are possible which also use the inventive idea and therefore fall within the scope of protection. In particular, the possibility of combining the features/aspects which have only been mentioned in the description and/or been shown in the figures with the features of the claims, in so far as they are compatible, is mentioned.

### BRIEF DESCRIPTION OF THE DRAWINGS

FIGS. 1a, 1b show perspective views of an embodiment of a windrow forming device;

FIGS. 2a-b show perspective views of components of the windrow forming device shown in FIGS. 1a, 1b;

FIG. 3 shows front views of the windrow forming device shown in FIGS. 1a, 1b during use;

FIG. 4a shows a perspective view of components of a second embodiment of a windrow forming device;

FIG. 4b shows a cross section of the second embodiment of the windrow forming device;

FIG. 5 shows front views of the second embodiment of the windrow forming device during use;

FIG. 6 shows a perspective view of components of a third embodiment of a windrow forming device;

FIG. 7 shows front views of the third embodiment of the windrow forming device during use.

In the figures, similar components/features are denoted with the same reference signs.

### DETAILED DESCRIPTION OF THE INVENTION

The windrow forming device 1; 101; 201 shown in the figures may be incorporated both in a self-propelled agricultural machine (not shown) and in a pulled agricultural machine (not shown). In the case of application of the device in a merger such as is known from WO2020/046114 A1, the merger comprises at least two windrow forming devices 1; 101; 201, so that besides deposition to the left or right of the merger, central deposition is also possible. For details of a merger, reference is made to WO2020/046114 A1.

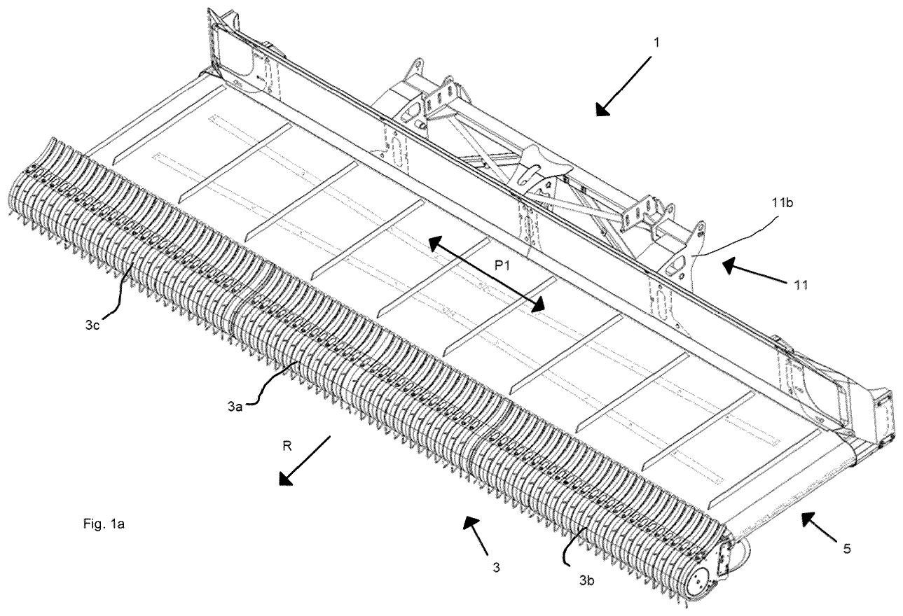

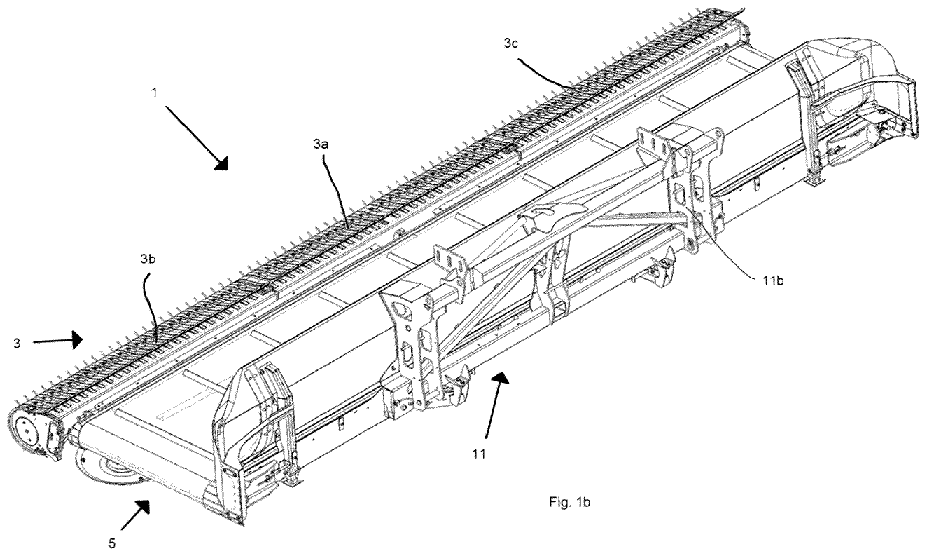

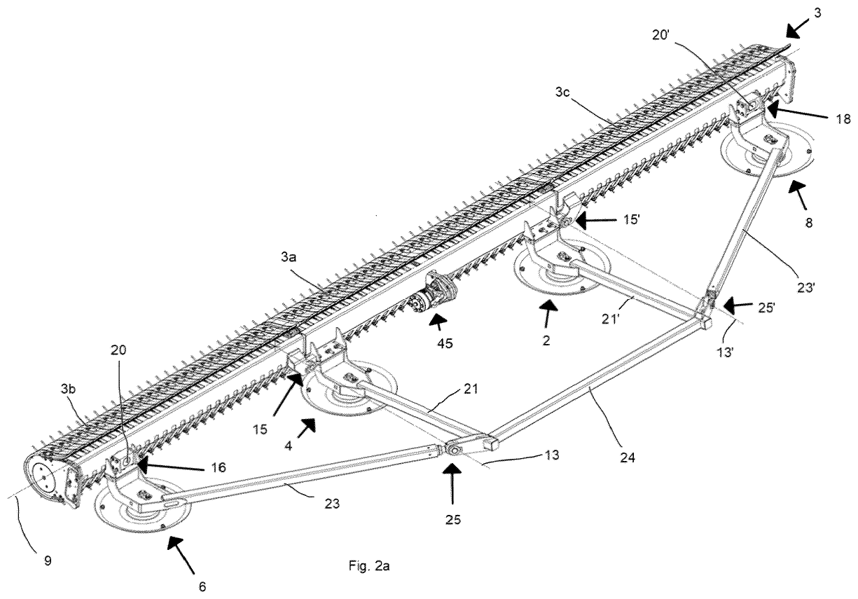

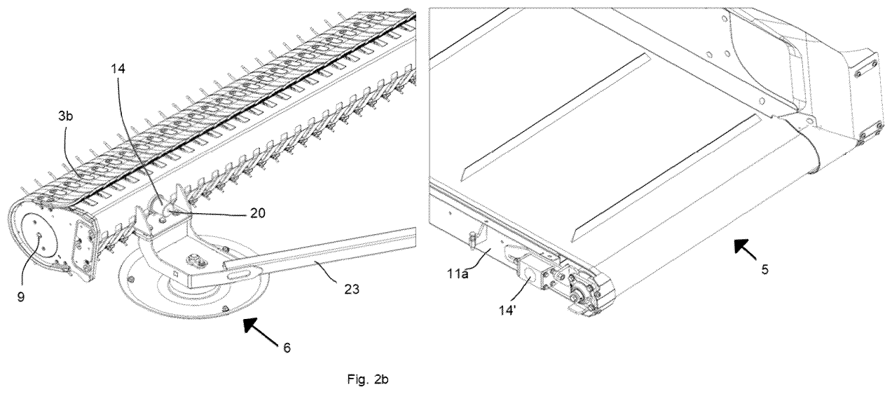

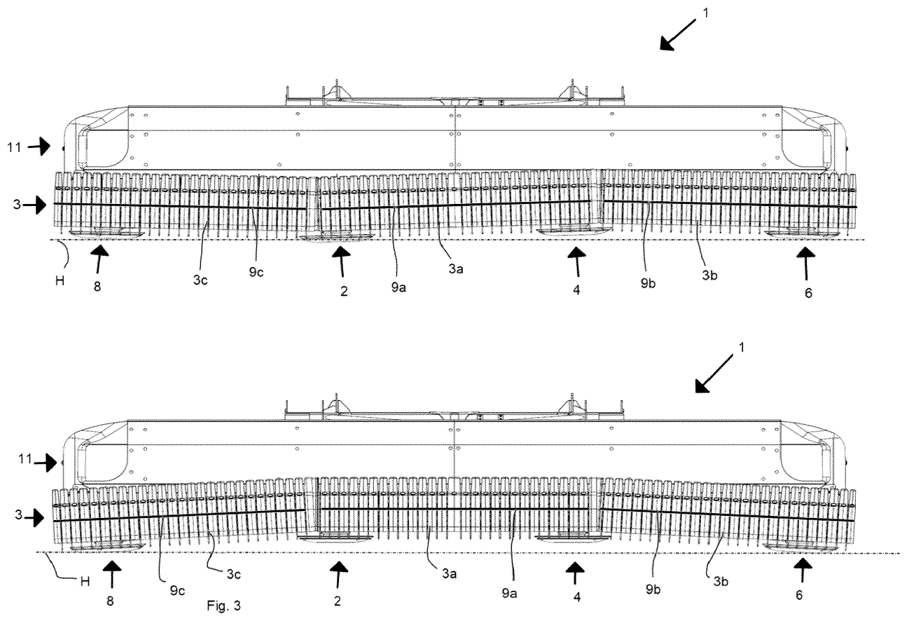

By means of the windrow forming device 1; 101; 201 shown in the figures, in operation, an agricultural working (processing) of the land is to be carried out. More particularly, each device 1; 101; 201 of elongated configuration shown is provided with a product pick-up mechanism unit 3; 103; 203 for picking up a plant material product from the land, for example for picking up hay or a similar product, as well as a transport mechanism, i.e. a conveyor belt 5, wherein by means of the conveyor belt 5, product picked up by means of the pick-up mechanism unit 3; 103; 203 is to be conveyed (transported) in one of the transport directions represented by arrow P1 (FIG. 1a), i.e. sideways relative to the direction of travel R (FIG. 1a) of the agricultural machine (not shown) and the device 1 and is to be deposited on the land. The elongate conveyor belt 5 extends mainly in a direction traverse to the direction of travel. The elongate conveyor belt 5 may be connected in a rigid manner to the rigid frame 11 such that the frame 11a (FIG. 2b) of the elongate conveyor belt 5 is part of the rigid frame 11 of the device 1; 101; 201. The rigid frame 11 also has a connection frame section 11b for connecting the device 1; 101; 201 to an agricultural machine, wherein the at least one transport mechanism, i.e. the elongate conveyor belt 5, extends between the pick-up mechanisms 3; 103; 203 and the connection frame section 11b of the rigid frame. For the sake of brevity and to avoid duplication, it is noted that the elongate conveyor belt 5 and the rigid frame 11 are identical or more or less identical in the devices 1; 101; 201 as shown in the figures, such that in the figures showing these features the same reference signs are used. The pick-up mechanism unit 3; 103; 203 comprises multiple pick-up mechanisms, wherein each pick-up mechanism comprises a pick-up rotor with a rotation axis 9a-c (FIGS. 3, 5 and 7), which is configured to pick up product from the land by means of a rotating motion about the rotation axes 9a-c extending substantially parallel to the direction of transport P1 of the conveyor belt 5. The rotation axes 9a-c are also commonly indicated with reference sign 9 in the figures. The conveyor belt 5 of the device will deposit product in an efficient and uniform manner back on the land to the left or right relative to a direction of travel R for forming a windrow. Using the conveyor belt 5 assures excellent transport of the product for forming windrows independent of the conditions, such as the condition of the product or weather conditions, in particular when windrows are being formed with high speeds in the direction of travel R, such as in the above mentioned merger.

The windrow forming device 1; 101; 201 may also comprise multiple conveyor belt sections (not shown) forming the conveyor belt 5, such that for example a first conveyor belt section is able to transport product in a first direction indicated with arrow P1, wherein a second conveyor belt section is able to transport product in a direction opposite to the first direction.

The windrow forming device 1; 101; 201 is provided with multiple pick-up mechanisms 3a, 3b, 3c; 103a, 103b; 203a, 203b and each pick-up mechanism comprises a pick-up rotor. The windrow forming device is further provided with at least one central ground following member 2, 4; 102; 202, wherein by means of the central ground following member 2, 4; 102; 202 the first pick-up mechanism 3a; 103a; 203a is pivotably mounted about a pivot axis 13, 13′ to the second pick-up mechanism 3b, 3c; 103b; 203b such that each pick-up mechanism 3a; 103a; 203a; 3b, 3c; 103b; 203b is configured to assume a first orientation in which the rotation axis 9a-c of the pick-up mechanism 3a; 103a; 203a; 3b, 3c; 103b; 203b extends parallel to the transport direction (P1) and at least a second orientation (see FIGS. 3, 5 and 7) in which the rotation axis 9a-c of the pick-up mechanism extends non-parallel to the transport direction (P1). In the first orientation, the rotation axis 9a-c of the pick-up mechanism extends for example horizontally such that in the second orientation the rotation axis 9a-c has an angle with the horizontal larger than 0° and equal to or smaller than 45° or most likely equal to or smaller than 30°. In FIGS. 3, 5 and 7 the horizontal H is indicated with a dotted line. Such a central rotary/pivot connection 15, 15′; 115; 215 between at least two pick-up mechanisms provides the advantages as mentioned above with respect to ground following performance, obstacle impact reduction and/or improved picking up product from the ground.

None of the pick-up mechanisms 3a, 3b, 3c; 103a, 103b; 203a, 203b of the windrow forming device 1; 101; 201 is connected in a non-pivotable manner to the rigid frame 11 which includes the frame 11b of the conveyor belt 5, such that all the pick-up mechanisms can move or rotate with respect to the rigid frame 11 and/or the conveyor belt 5.

The device 1; 101; 201 is further provided with at least three ground following 2, 4, 6, 8; 102, 106, 108; 202, 206, 208 members. The ground following members comprise at least one central ground following member 2, 4; 102; 202 which is located between two outer ground following members 6, 8; 106, 108; 206, 208.

The pivot axis 13, 13′ for pivotably mounting the pick-up mechanisms to each other extends essentially in the direction of travel R, in particular the pivot axis 13, 13′ forms an angle between 0° and approximately 45° with the direction of travel. It is beneficial from a constructional point of view if the pivot axis 13, 13′ intersects with the rotation axis 9, preferably at a substantially perpendicular angle, see FIGS. 2a, 4a and 6.

In the embodiments shown, the pick-up rotor of one of the pick-up mechanism can be driven solely by means of a drive unit 45 to mutually drive the pick-up rotors of all the other pick-up mechanism(s) of the device 1; 101; 201 in rotation around their rotation axes 9a-c. By means of a coupling between shafts of the pick-up mechanisms, for example an elastic coupling or a cardan coupling, the shafts can be coupled in a moveable manner with respect to each other, wherein the single drive unit 45 is able to drive the pick-up rotor of each pick-up mechanism Such a configuration with a single drive for all the pick-up mechanisms and/or the coupling provide a relatively simple, mechanically strong and reliable device. As a result of the flexible coupling, it is possible that the connected shafts defining the rotation axes can be moved in a mechanical stable manner from an aligned position, for example horizontal position, with respect to each other to an articulated, non-aligned, position, for example a non-horizontal position with respect to each other as a result of the pick-up mechanisms pivoting around the pivotable connections.

The pick-up mechanisms of the device 1; 101; 201 are elongate pick-up mechanisms with a length extending parallel to the length of the conveyor belt 5, wherein the length is the largest dimension of the pick-up mechanism. In an operative device 1; 101; 201, the length of the adjacently arranged pick-up mechanisms 3a-c; 103a,b; 203a,b extends in a direction substantially traverse to the direction of travel R. The total length of the pick-up mechanisms defines the working width of the windrow forming device. The lengths of the pick-up mechanisms may be substantially identical as shown in the figures.

As shown in FIGS. 1a-3, the windrow forming device 1 comprises a third pick-up mechanism 3c. In the device 1 with three pick-up mechanisms 3a-c, the first pick-up mechanism 3a is provided between the second pick-up mechanism 3b and the third pick-up mechanism 3c. The third pick-up mechanism 3c is pivotably mounted to the first pick-up mechanism 3a by means of a further central ground following member 2. The device 1 comprises at least four ground following members 2, 4, 6, 8 including two outer ground following members 6, 8 and at least two central ground following members 2, 4. FIG. 2a shows a pivot axis 13′ of the second central rotary/pivot connection 15′ between the first pick-up mechanism 3a and the third pick-up mechanism 3c.

The second 3b and third 3c pick-up mechanism are pivotably mounted to the rigid frame 11 by outer rotary/pivot connections 16, 18. The outer pivot connection 18 is configured to move in a direction substantially parallel to the rotation axis 9c of the third pick-up mechanism 3c, i.e. outer pivot connection 18 has a slot in which the pivot pin can rotate and displace in the slot to compensate for forces during use of the device. The arrangement of the pivotably mounted outer pick-up mechanisms 3b, 3c with respect to the first pick-up mechanism 3a provides a flexible device 1 with a relatively large working width and improved pick-up.

The conveyor belt 5 and/or the rigid frame 11 are not connected to the first pick-up mechanism 3a in a direct manner. The conveyor belt 5 is directly connected to the second pick-up mechanism 3b and the third pick-up mechanism 3c, i.e. the second and third pick-up mechanism 3b, 3c are connected to frame 11a of the rigid frame 11 by means of a pivot pin 14 (see FIG. 2b) received in a pivot hole 14′ or pivot slot to provide outer rotary/pivot connections 16, 18. The first pick-up mechanism 3a is indirectly connected to the transport mechanism 5 or to the rigid frame 11 by means of the outer pivot connections 16, 18. The central ground following members are also indirectly connected to the transport mechanism 5 or to the rigid frame 11 by means of the outer pivot connections 16, 18.

As shown in FIG. 2a, each outer ground following member 6, 8 is connected to a central connector 21, 21′ of one of the two central ground following members 2, 4 by a hinge mechanism 25, 25′. One end of each central connector 21, 21′ is connected to one of the two central ground following members 2, 4. At a distance from the respective central ground following member 2, 4, the hinge mechanism 25, 25′ is connected to the central connector 21, 21′, i.e. near its end opposite to one of the two central ground following members 2, 4. Each pivot axis 13, 13′ intersects with the center of each hinge mechanism 25, 25′. Each outer ground following member 6, 8 is connected to the central connector by means of an elongate connector 23, 23′. The central connectors 21, 21′ are also elongate and connected with each other by means of connector 24 near theirs ends opposite to the two central ground following members 2, 4. The ends opposite to the two central ground following members 2, 4 are free ends, i.e. ends which are not connected to the rigid frame 11.

In the device 1, the central ground following members 2, 4 are configured to be moveable with respect to the ground (for example horizontal line H in FIG. 3) in a vertical direction, wherein the outer ground following members 6, 8 are configured to support this movement with respect to the ground (see lower drawing in FIG. 3).

In addition or alternatively, the outer ground following members 6, 8 are configured to be moveable with respect to the ground in a vertical direction (for example horizontal line H in FIG. 3), wherein the central ground following members 2, 4 are configured to support this movement with respect to the ground.

The rotation axes 9a-c of the three pick-up mechanisms 3a-c are identified in FIG. 3, and it is visible that these three rotation axes 9a-c of the three pick-up mechanisms 3a-c are non-aligned in the working positions of the device shown in FIG. 3. On a flat ground, these rotation axes 9a-c will be aligned (not shown). On a horizontal flat ground, these rotation axes 9a-c will be aligned along a horizontal line (not shown).

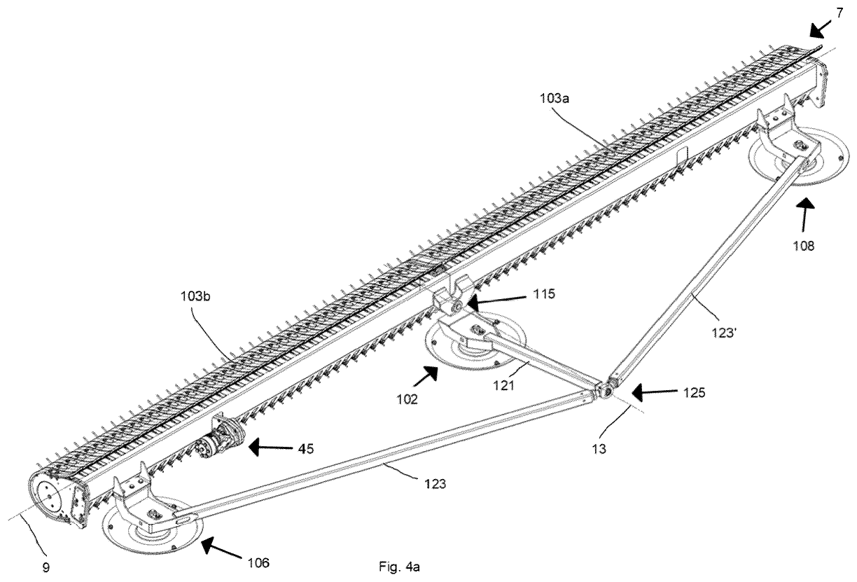

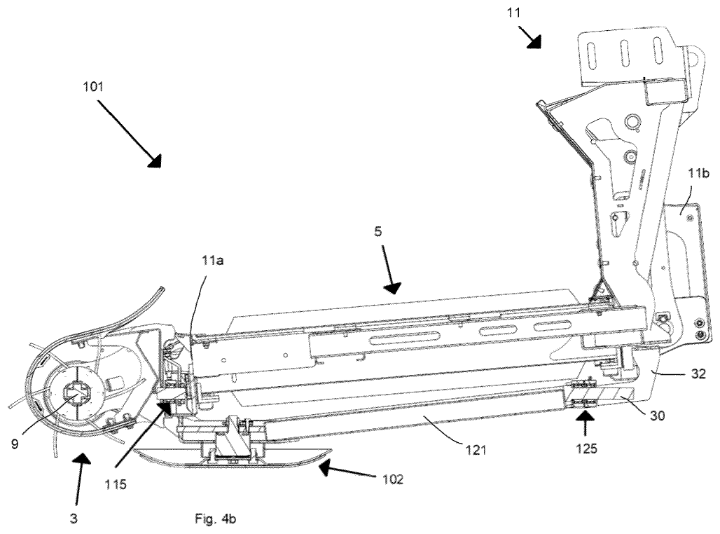

As shown in FIG. 4 a,b and 5, the windrow forming device 101 comprises two pick-up mechanisms 103a, 103b, wherein by means of the central ground following member 102 the first pick-up mechanism 103a is pivotably mounted about a pivot axis 13 to the second pick-up mechanism 103b. The outer ground following members 106, 108 of the device 101 are connected to the first pick-up mechanism 103a and the second pick-up mechanism 103b in a fixed non-pivotable manner, i.e. a rigid manner. By means of this configuration of the device 101, the outer ground following members 106, 108 are configured to be moveable with respect to the ground in a vertical direction and the central ground following member 102 is configured to support this movement. The central ground following member 102 provides a pivot connection 115 for pivotably mounting the first pick-up mechanism 103a with respect to the second pick-up mechanism 103b about the pivot axis 13. In FIG. 5, the lower drawing shows that the central ground following member 102 is supported by the ground, which near the central ground following member 102 extends in a horizontal manner, but near the outer ground following members 106, 108 the ground does not follow the horizontal line H, i.e. the ground is not shown but lies lower than horizontal line H. In the device 101, central ground following member 102 is always in contact with the ground for supporting the device 101.

The outer ground following members 106, 108 are connected to the rigid carrier 121 in a pivotable manner at a distance from the central ground following member 102. The outer ground following members 106, 108 are connected to the rigid carrier 121 by means of a single pivot connection 125 having a pivot axis extending essentially in the direction of travel R, in particular the pivot axis forms an angle between 0° and approximately 45° with the direction of travel R. Each outer ground following member 106, 108 is connected to the pivot connection 125 by means of an elongate connector 123, 123′. As can be seen in FIG. 4a, the pivot axis 13 of the pivot connection 115 intersects the center of the pivot connection 125.

Contrary to the device 1, the central ground following member 102 with the pivot connection 115 is connected in a rigid manner to the rigid frame 11 of the device 101, in particular the connection frame section 11b of the rigid frame 11. In the embodiment shown, the central ground following member 102 is connected in a rigid manner to the rigid frame by a rigid carrier, for example an elongate rigid carrier 121, such that the central ground following member is connected in a rigid manner to a connection frame section 11b of the rigid frame 11 by the rigid carrier 121. As shown in FIG. 4b, a pin 30 of bracket 32 is attached in the pivot connection 125, wherein the bracket 32 is part of a connection frame section 11b of the rigid frame 11.

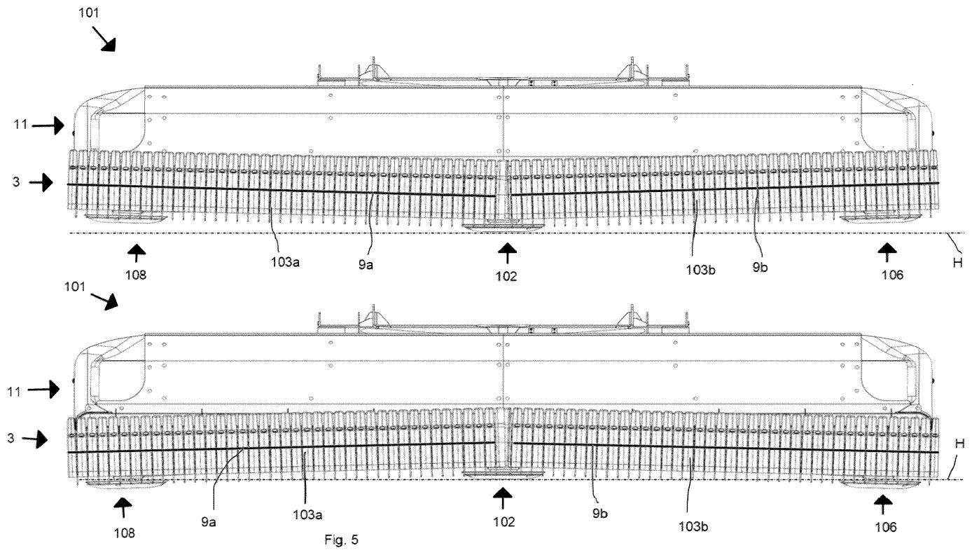

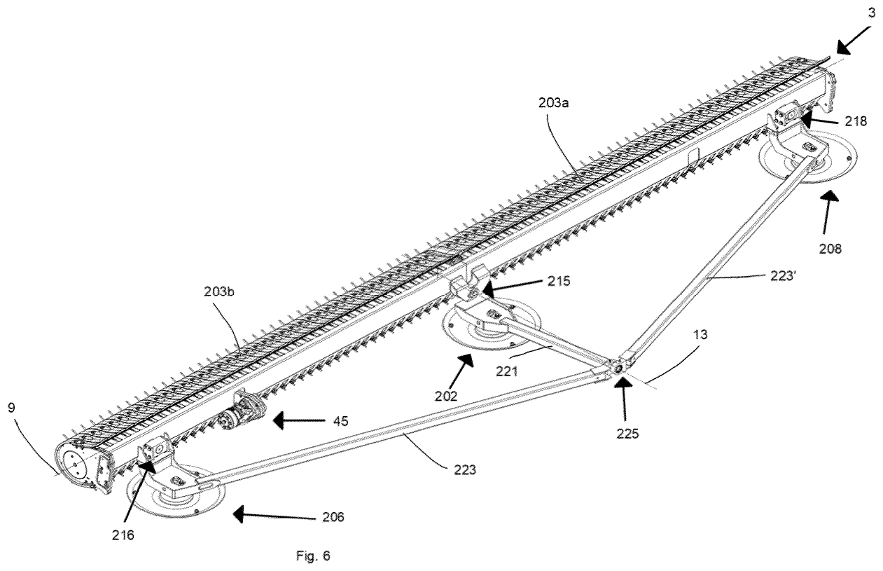

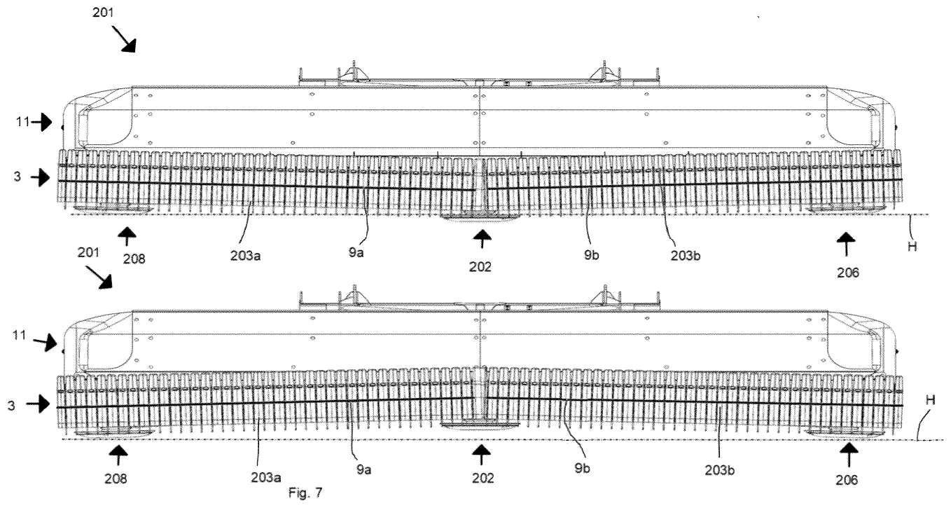

As shown in FIGS. 6 and 7, the windrow forming device 201 comprises two pick-up mechanisms 203a, 203b, wherein by means of the central ground following member 215 the first pick-up mechanism 203a is pivotably mounted about a pivot axis 13 to the second pick-up mechanism 203b. The first pick-up mechanism 203a and the second pick-up mechanism 203b are pivotably mounted with respect to the outer ground following members 206, 208 by means of outer pivot connections 216, 218. The pivot connection 218 is provided with a slotted hole, such that the outer pivot connection 218 is configured to pivot and move in a direction substantially parallel to the rotation axis 9a of the respective pick-up mechanism 203a.

In the device 201, the central following member 202 is configured to be moveable with respect to the ground in a vertical direction. This vertical movement is shown in FIG. 7. The outer ground following members 206, 208 are configured to support this movement with respect to the ground.

The outer ground following members 206, 208 are connected at a distance from the central ground following member 202 in a pivotable manner to a central connector 221 connected with one end thereof to the central ground following member 202. The outer ground following members 206, 208 are connected to the central connector 221 by means of a single pivot connection 215 having a pivot axis extending essentially in the direction of travel R, in particular the pivot axis forms an angle between 0° and approximately 45° with the direction of travel R. Each outer ground following member 206, 208 is connected to the single pivot connection by means of an elongate connector 223, 223′. The end opposite to the central ground following member 202 is a free end, i.e. this end is not connected to the rigid frame 11.

1. A windrow forming device which is movable over ground in a direction of travel, wherein the device comprises:
a first pick-up mechanism and a second pick-up mechanism for picking up a product from the ground, each pick-up mechanism comprises a pick-up rotor with a rotation axis;
at least one transport mechanism, comprising a conveyor belt, arranged to convey picked up material in at least one transport direction extending sidewards with respect to the direction of travel, and to deposit said material on the ground for forming a windrow;
at least one ground following member, wherein by the ground following member the first pick-up mechanism is pivotably mounted about a pivot axis to the second pick-up mechanism such that each pick-up mechanism is configured to assume a first orientation in which the rotation axis of the pick-up mechanism extends parallel to the transport direction and at least a second orientation in which the rotation axis of the pick-up mechanism extends non-parallel to the transport direction.

2. The device according to claim 1, wherein the device further comprises a rigid frame, comprising a frame of the at least one transport mechanism, wherein the first pick-up mechanism and the second pick-up mechanism are adapted to move or pivot with respect to the rigid frame.

3. The device according to claim 1, wherein the pivot axis for pivotably mounting the pick-up mechanisms to each other extends essentially in the direction of travel, the pivot axis forms an angle between 0° and approximately 45° with the direction of travel.

4. The device according to claim 1, wherein in the second orientation of the pick-up mechanisms the rotation axis has an angle with a horizontally extending transport direction, larger than 0° and equal to or smaller than 45°.

5. The device according to claim 1, wherein the pivot axis intersects with the rotation axis at a substantially perpendicular angle.

6. The device according to claim 2, wherein the rigid frame has a connection frame section for connecting the device to an agricultural machine, wherein the at least one transport mechanism extends between the pick-up mechanisms and the connection frame section of the rigid frame.

7. The device according to according to claim 1, wherein the device further comprises at least three ground following members, comprising a central ground following member located between two outer ground following members.

8. The device according to claim 7, wherein the outer ground following members are connected to the first pick-up mechanism and the second pick-up mechanism in a fixed non-pivotable manner.

9. The device according to claim 7, wherein the outer ground following members are configured to be moveable with respect to the ground in a vertical direction and the central ground following member is configured to support movement.

10. The device according to claim 2, wherein the central ground following member comprises a pivot connection for pivotably mounting the first pick-up mechanism with respect to the second pick-up mechanism about the pivot axis, wherein the central ground following member with the pivot connection is connected in a rigid manner to the rigid frame.

11. The device according to claim 10, wherein the central ground following member is connected in a rigid manner to the rigid frame by a rigid carrier comprising an elongate rigid carrier, the central ground following member is connected in a rigid manner to a connection frame section of the rigid frame by the rigid carrier.

12. The device according to claim 11, wherein the outer ground following members are connected to the rigid carrier in a pivotable manner at a distance from the central ground following member, the outer ground following members are connected to the rigid carrier by a single pivot connection having a pivot axis extending essentially in the direction of travel, the pivot axis forms an angle between 0° and approximately 45° with the direction of travel, each outer ground following member is connected to the single pivot connection by an elongate connector.

13. The device according to claim 7, wherein the first pick-up mechanism and the second pick-up mechanism are pivotably mounted with respect to the outer ground following members by outer pivot connections, at least one of the two outer pivot connections is configured to move in a direction substantially parallel to the rotation axis of the respective pick-up mechanism.

14. The device according to claim 13, wherein the central following member is configured to be moveable with respect to the ground in a vertical direction, wherein the outer ground following members are configured to support movement with respect to the ground.

15. The device according to claim 13, wherein the outer ground following members are connected at a distance from the central ground following member in a pivotable manner to a central connector connected to the central ground following member, the outer ground following members are connected to the central connector by a single pivot connection having a pivot axis extending essentially in the direction of travel, the pivot axis forms an angle between 0° and approximately 45° with the direction of travel, each outer ground following member is connected to the single pivot connection by an elongate connector.

16. The device according to claim 1, wherein the device further comprises a third pick-up mechanism, wherein the first pick-up mechanism is between the second pick-up mechanism and the third pick-up mechanism, wherein the third pick-up mechanism is pivotably mounted to the first pick-up mechanism by a further central ground following member, wherein the device comprises at least four ground following members including two outer ground following members and at least two central ground following members.

17. The device according to claim 16, wherein the central ground following members are configured to be moveable with respect to the ground in a vertical direction, wherein the outer ground following members are configured to support movement with respect to the ground.

18. The device according to claim 16, wherein the outer ground following members are configured to be moveable with respect to the ground in a vertical direction, wherein the central ground following members are configured to support movement with respect to the ground.

19. The device according to claim 16, wherein each outer ground following member is connected to a central connector of one of the two central ground following members by a hinge mechanism at a distance from the respective central ground following member, and/or the pivot axis intersects with the center of the hinge mechanism, each outer ground following member is connected to the central connector by an elongate connector.

20. The device according to claim 16, wherein the second pick-up mechanism and the third pick-up mechanism are pivotably mounted with respect to the outer ground following members by outer pivot connections, at least one of the two outer pivot connections is configured to move in a direction substantially parallel to the rotation axis of the respective pick-up mechanism.

21. The device according to claim 20, wherein the first pick-up mechanism is indirectly connected to the transport mechanism or to the rigid frame by the outer pivot connections and/or the central ground following members are indirectly connected to the transport mechanism or to the rigid frame by the outer pivot connections.

22. The device according to claim 1, wherein one of the pick-up mechanisms is drivable to mutually drive the other pick-up mechanism(s) of the device in rotation around the rotation axis and/or the pick-up mechanisms comprise at least one coupling between rotary shafts of the pick-up mechanisms, the at least one coupling comprising an elastic coupling or a cardan coupling.

23. A self-propelled merger, or a pulled agricultural machine, wherein said agricultural machine comprises at least one windrow forming device according to claim 1, and/or
the at least one windrow forming device is moveable from a transport position to a working position, and vice versa, wherein in the working position a maximum width of the agricultural machine seen in a direction traverse to the direction of travel is at least 1.5 times larger by the at least one device than in the transport position.

24. (canceled)
